(19) United States
(12) Patent Application Publication
(10) Pub. No.: US 2009/0074234 A1
(43) Pub. Date: Mar. 19, 2009

(54) SYSTEM AND METHOD FOR CAPTURING IMAGES

(75) Inventor: SHIH-HSIANG YEN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/141,084

(22) Filed: Jun. 18, 2008

(30) Foreign Application Priority Data
Sep. 14, 2007 (CN) 200710201718.7

(51) Int. Cl. G06K 9/00

(52) U.S. Cl. 382/100

(57) ABSTRACT

An exemplary method for capturing images includes steps of: focusing on a scene, wherein the scene comprises at least one person; locating irises of the at least one person on an image of the scene; measuring a diameter and a height of each of the irises; comparing the ratio of the height to the diameter with a predetermined ratio to determine whether the at least one person's eyes are blinking or closed; capturing at least two images of the at least one person in quick succession if the at least one person's eyes are not blinking or closed; and selecting an optimum image from one of the at least two images. A system for capturing images is also provided.

### BACKGROUND

1. Technical Field

The present invention relates to a system and method for capturing images.

2. Description of the Related Art

Image capturing devices, such as digital cameras, are well known and widely used for capturing images. Some conventional image capturing devices have functions of focusing on a scene or target and performing face detection. However, those image capturing devices cannot prevent capturing an image of a person who happens to blink or close eyes at the moment of image capturing.

What is needed, therefore, is a system and method for capturing images, which can capture images at appropriate moments automatically, so as to avoid capturing images of people at the moment they blink and enhance image quality.

### SUMMARY

A computer-enabled method for capturing images includes the following steps: focusing on a scene, wherein the scene comprises at least one person; locating irises of the at least one person on an image of the scene; measuring a diameter and a height of each of the irises; comparing the ratio of the height to the diameter with a predetermined ratio to determine whether the at least one person's eyes are blinking or closed; capturing at least two images of the at least one person in quick succession if the at least one person's eyes are not blinking or closed; and selecting an optimum image from one of the at least two images.

Other novel features of the present invention will become more apparent from the following detailed description of the exemplary embodiments when taken in conjunction with the accompanying drawings.

### BRIEF DESCRIPTION OF THE DRAWINGS

FIG. 1 is a block diagram illustrating hardware configuration of a system for capturing images in accordance with one exemplary embodiment.

FIG. 2 is a block diagram of functional modules of the measuring unit of FIG. 1.

FIG. 3 is showing a schematic and graph diagrams of a flow to locate irises of a person.

FIG. 4 is a schematic diagram illustrating a diameter of one iris in FIG. 3.

FIG. 5 is a schematic diagram of measuring a height of one iris in FIG. 3.

FIG. 6 is a flowchart of a method for capturing images in accordance with another exemplary embodiment.

### DETAILED DESCRIPTION OF THE EMBODIMENTS

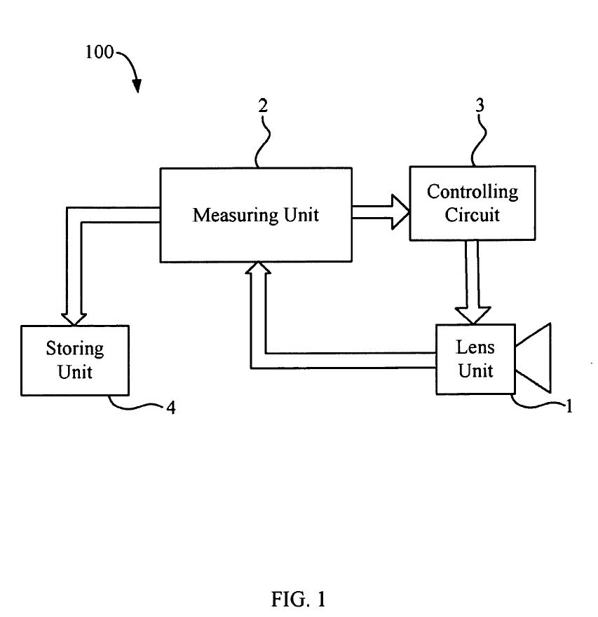

FIG. 1 is a block diagram illustrating hardware configuration of a system for capturing images (hereinafter, “the system”) in accordance with an exemplary embodiment. The system is implemented in an image capturing device 100 (e.g., a digital camera, or a digital video camera), and typically includes a lens unit 1, a measuring unit 2, a controlling circuit 3, and a storing unit 4. The measuring unit 2 is configured for controlling the lens unit 1 to focus on a scene or target and to capture an image via the controlling circuit 3. The lens unit 1 is configured for converting the image into a digital image, and sending the digital image to the measuring unit 2. The measuring unit 2 determines whether any person captured in the image is blinking or has their eyes closed by measuring irises found in the digital image, if not, then captures additional images (at least two) in quick succession, finds and compares irises from one image to the next to find an optimum image. The idea here is that the image with the most amounts of irises indicates that the subjects in the image have their eyes open and are not in the process of blinking or shutting their eyes. The optimum image is saved in the storing unit 4.

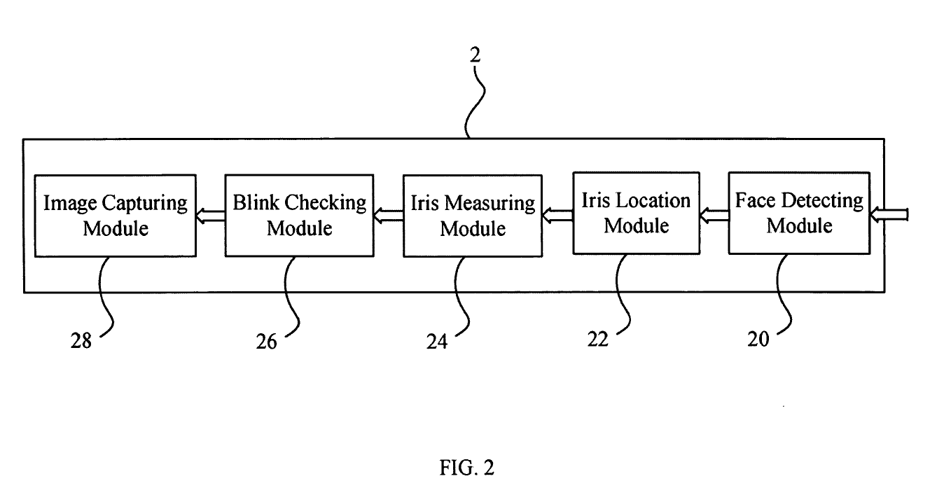

FIG. 2 is a block diagram of functional modules of the measuring unit 2 of FIG. 1. The measuring unit 2 mainly includes a face detecting module 20, an iris location module 22, an iris measuring module 24, a blink checking module 26 and an image capturing module 28.

When the lens unit 1 is focusing on the scene, the face detecting module 20 is configured for scanning an image of the scene to locate the head of each person in the image, and ascertaining the facial area of each head using any known method of facial recognition. Then, the face detecting module 20 continues using the facial recognition method or other suitable method to determine if the head is facing the image capturing device by locating two eyes in the facial area.

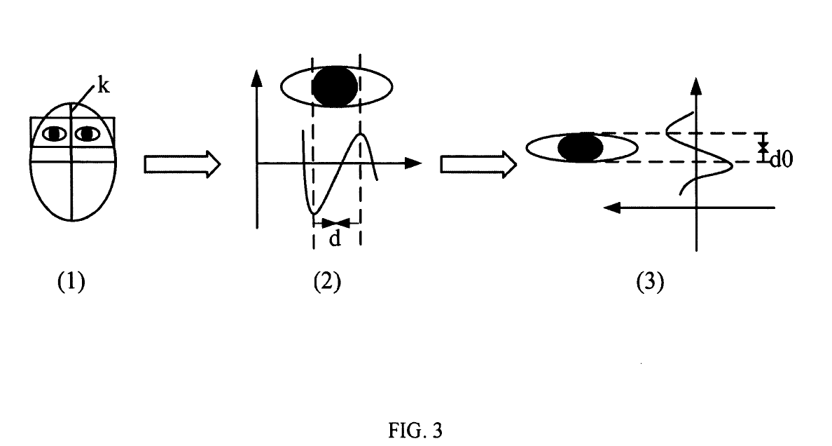

The iris location module 22 is configured for finding the irises of the eyes in the facial area of each head facing the image capturing device. Referring to FIG. 3, this is accomplished by designating a rectangular area, then on the facial area such that it mainly encompasses the eyes, as shown in FIG. 3(1). The iris location module 22 then performs a wavelet transform on the eye areas to locate the irises in the eyes. A wavelet transform on one of the eyes are illustrated by the graph diagrams shown in FIG. 3(2) and FIG. 3(3).

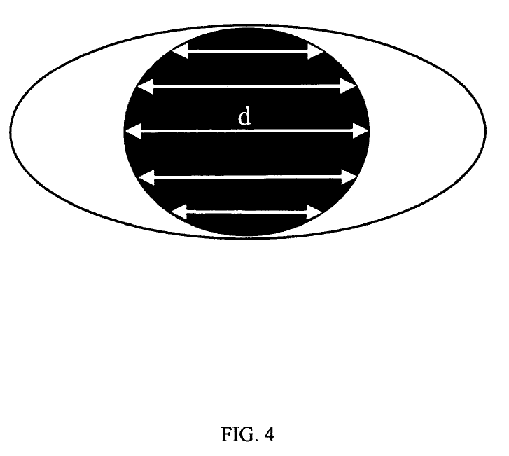

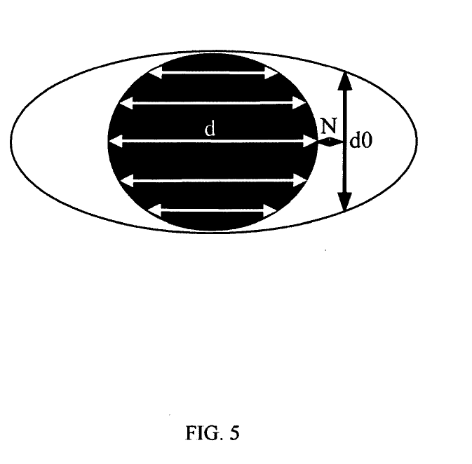

Referring to FIGS. 3 through 5, the iris measuring module 24 is configured for measuring a diameter “d” of each iris along the horizontal direction in each of the eyes. The iris measuring module 24 is further configured for measuring a height “d0” of each iris. Even if person in an image does not have their eyes open as in FIG. 4, the iris measuring module 24 can still measure the height “d0” by doing the following processing: finding a point that is away from the measured diameter for a distance “N” in the horizontal direction; and drawing a vertical line that interconnects the point and extends to the peripheries of the eyes; and measuring a height of the vertical line that represents the height “d0” of the iris. The height “d0” of the iris is equal to the height of the vertical line. In the exemplary embodiment, “N” is between about 0.5 millimeters to 2 millimeters. If the person in the image has his/her eyes closed, the diameter “d” and the height “d0” of each iris of the person are both equal to zero.

The blink checking module 26 is configured for checking whether the person is blinking by comparing the height “d0” with the diameter “d” of each iris, and determining whether a ratio of the height “d0” to the diameter “d” is less than a predetermined ratio “PR” that is input into the image capturing device in advance. A user may override the “PR” by manually selecting a ratio “PR” somewhere between about ⅓ to ½, to compensate for eyes that are unusually large or small. In this embodiment, the height “d0” is equal to one-half of the diameter “d.”

If the ratio of the height “d0” to the diameter “d” is less than the “PR,” the blink checking module 26 ascertains that the person is blinking, and then informs the user that the person is blinking via the controlling circuit 3, for example, renders a message or an image or an audible warning.

Otherwise, if the ratio of the height “d0” to the diameter “d” is larger than or equal to the “PR,” the blink checking module 26 ascertains that the person is not blinking. It then notifies the image capturing module 28 to proceed.

The image capturing module 28 is configured for receiving at least two digital images transmitted from the lens unit 1 in quick succession after receiving the information that the person is not blinking or has his/her eyes closed. The iris measuring module 24 measures the diameter “d” and the height “d0” of each iris in the at least two images. And then, the image capturing module 28 is further configured for selecting one of the two or more images as a reserve image. The height “d0” of the reserve image is larger than the other images captured by the image capturing module 28. If the ratio of the height “d0” to the diameter “d” of the reserve image is larger than or equal to the “PR,” the image capturing module 28 saves the reserve image as the optimum image. The optimum image is stored in the storing unit 4.

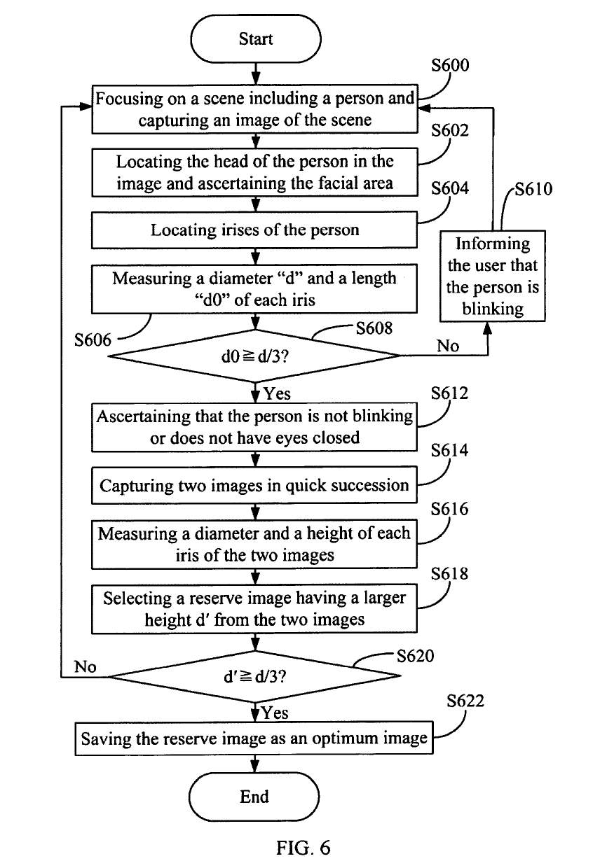

FIG. 6 is a flowchart of a method for capturing images in accordance with another exemplary embodiment, which can be employed by the image capturing device 100. In step S600, the lens unit 1 focuses on a scene that includes at least one person, and captures an image of the scene. In the exemplary embodiment, for briefness, the one person is described as an object in the scene.

In step S602, the face detecting module 20 scans the image of the scene to locate the head of the person in the image, and ascertains the facial area of the head using any known method of facial recognition.

In step S604, the iris location module 22 locates the irises of the eyes in the facial area. A detailed description is as follows. At first, the iris location module 22 designates a rectangular area on the facial area such that it mainly encompasses the eyes (referring to FIG. 3(1)). Then, the iris location module 22 performs wavelet transform on the eyes to locate the irises in the eyes. A wavelet transform on one of the eyes are illustrated by the graph diagrams shown in FIG. 3(2) and FIG. 3(3).

In step S606, the iris measuring module 24 measures the diameter “d” of each iris along the horizontal direction of the eyes, and measures the height “d0” of each iris. The measuring step includes the following steps: finding a point that is away from the diameter of the iris for a distance “N” in the horizontal direction; and drawing a vertical line that interconnects the point and extends to the peripheries of the eyes. The height “d0” of the iris is equal to the height of the vertical line. In the embodiment, “N” is between about 0.5 millimeters to 2 millimeters. If the person has his/her eyes closed, the diameter “d” and the height “d0” of each iris of the person are both equal to zero.

In step S608, the blink checking module 26 checks whether the person is blinking by comparing the height “d0” with the diameter “d” of each iris, and determines whether a ratio of the height “d0” to the diameter “d” is less than the “PR” that is predetermined and stored in the image capturing device in advance. The exemplary embodiment gives an example that the “PR” equals ⅓. Thus, the blink checking module 26 checks whether the person blinks eyes by determining whether the height “d0” is larger than or equal to a third of the diameter “d” that corresponds to the height “d0.”

If d0<d/3, in step S610, the blink checking module 26 ascertains that the person is blinking, and informs the user that the person is blinking via the controlling circuit 3, such as causing a message or an image to be displayed or perhaps, an audible warning to be played, and then the procedure returns to the step S600 after a period of time. The range of the period of time is between about 200 milliseconds to 500 milliseconds.

Otherwise, if d0≧d/3, in step S612, the blink checking module 26 ascertains that the person is not blinking, and notifies the image capturing module 28 to proceed.

In step S614, the image capturing module 28 captures the at least two images in quick succession via the lens unit 1 after receiving the notification that the person is not blinking or does not have his/her eyes closed. In the embodiment, two images are captured and used to explain how to determine the optimum image. For example, the image capturing module 28 captures a first image and a second image in quick succession.

In step S616, the iris measuring module 24 measures the diameter “d” and the height “d0” of each iris in the first image and the second image.

In step S618, the image capturing module 28 selects a reserve image from the first image and the second image by comparing the height “d0” of the first image with that of the second image. For example, if the heights “d0” in the first image are larger than that of the second image, the image capturing module 28 ascertains the first image as the reserve image; if any height “d0” in the first image is less than any height “d0” of the second image, or all heights “d0” of the first image are equal to that of the second image, the image capturing module 28 ascertains any of the first image and the second image as the reserve image.

In the step S620, the image capturing module 28 determines whether the height “d′” of the reserve image is larger than or equal to a third of the corresponding diameter “d” of the reserve image.

If d′≧d/3, the image capturing module 28 saves the reserve image as the optimum image in the storing unit 4. Otherwise, if d′<d/3, the procedure returns to the step S600.

It is to be understood, however, that even though numerous characteristics and advantages of the present invention have been set forth in the foregoing description, together with details of the structure and function of the invention, the disclosure is illustrative only and changes may be made in details, especially in matters of shape, size and arrangement of parts within the principles of the invention to the full extent indicated by the broad general meaning of the terms in which the appended claims are expressed.

What is claimed is:

1. A method for capturing images through an image capturing device, the method comprising:
focusing on a scene, wherein the scene comprises at least one person;
locating irises of the at least one person on an image of the scene;
measuring a diameter and a height of each of the irises;
comparing the ratio of the height to the diameter with a predetermined ratio to determine whether the at least one person's eyes are blinking or closed;
capturing at least two images of the at least one person in quick succession if the at least one person's eyes are not blinking or closed; and
selecting an optimum image from one of the at least two images.

2. The method as described in claim 1, wherein the comparing step is further comprises steps of:
informing a user that the at least one person's eyes are blinking or closed if the ratio is less than the predetermined ratio, and repeating from the focusing step to the comparing step.

3. The method as described in claim 1, wherein the selecting step comprises steps of:
measuring the diameter and the height of each iris of the at least two images, and selecting a reserve image from the at least two images, wherein the height of each iris of the reserve image is larger than those of the other images;
determining whether a ratio of the height to the diameter of each iris in the reserve image is less than the predetermined ratio; and
ascertaining the reserve image as the optimum image, if the ratio of the height to the diameter of each iris in the reserve image is larger than or equal to the predetermined ratio; or
repeating from the focusing step to the determining step, if the ratio of the height to the diameter of each iris in the reserve image is less than the predetermined ratio.

4. The method as described in claim 1, wherein the predetermined ratio is between about ⅓ to ½.

5. The method as described in claim 1, wherein the locating step comprises steps of:
scanning the image to locate the head of the at least one person;
ascertaining the facial area of the head in the image;
designating a rectangular area on the facial area such that it mainly encompasses the eyes of each of the at least one person; and
performing a wavelet transform on the eyes to locate the irises in the eyes.

6. The method as described in claim 1, wherein the height of each iris is measured by steps of:
finding a point that is away from the diameter of each iris for a distance in the horizontal direction;
drawing a vertical line that interconnects the point and extends to the peripheries of the eyes; and
measuring a height of the vertical line that represents the height of the iris.

7. A system for capturing images, the system comprising:
a lens unit; and
a measuring unit, comprising:
an iris location module configured for locating irises of at least one person in an image;
an iris measuring module configured for measuring a diameter of each iris along the horizontal direction, and a height of each iris corresponding to the diameter;
a blink checking module configured for determining whether the at least one person's eyes are not blinking or closed by comparing a ratio of the height to the diameter with a predetermined ratio, and prompting information according to the comparison result; and
an image capturing module configured for capturing at least two images in quick succession via the lens unit after receiving the information that the at least one person's eyes are not blinking or closed, and selecting an optimum image from one of the at least two images.

8. The system as described in claim 7, wherein the image capturing module is further configured for selecting a reserve image from one of the at least two images, and saving the reserve image as the optimum image if a ratio of each height of the reserve image to the corresponding diameter is larger than or equal to the predetermined ratio.

9. The system as described in claim 8, wherein the predetermined ratio is between about ⅓ to ½.

10. The system as described in claim 8, wherein the height of each iris of the reserve image is larger than those of the other images.

11. The system as described in claim 7, wherein the height of each iris is measured by ways of finding a point that is away from the diameter for a distance in the horizontal direction, drawing a vertical line that interconnects the point and extends to the peripheries of the eyes, and measuring a height of the vertical line.

12. The system as described in claim 1, wherein the distance is between about 0.5 millimeters to 2 millimeters.

13. The system as described in claim 7, wherein the measuring unit further comprises a face detecting module configured for scanning the image to locate the head of the at least one person and ascertaining the facial area of the head in the image.

14. The system as described in claim 13, wherein the iris location module is further configured for designating a rectangular area on the facial area such that it mainly encompasses the eyes of each of the at least one person, and performing a wavelet transform on the eyes to locate the irises in the eyes.

15. The system as described in claim 7, further comprising a controlling circuit for controlling the lens unit by the measuring unit.
